(19) United States
(12) Patent Application Publication
(10) Pub. No.: US 2015/0096440 A1
(43) Pub. Date: Apr. 9, 2015

(54) POSITION SENSOR ASSEMBLY IN A HYDRAULIC CYLINDER

(71) Applicant: Caterpillar Inc., Peoria, IL (US)

(72) Inventor: Michael Subrt, Chillicothe, IL (US)

(73) Assignee: Caterpillar Inc., Peoria, IL (US)

(21) Appl. No.: 14/045,338

(22) Filed: Oct. 3, 2013

(51) Int. Cl. F15B 15/28

(52) U.S. Cl. CPC F15B 15/2815
USPC 92/5 R

(57) ABSTRACT

A position sensor assembly for the hydraulic cylinder having a piston and piston rod is provided. The position sensor assembly includes a pressure to electric energy convertor, a transmitter and a receiver. The pressure to electric energy convertor is disposed inside the piston. The pressure to electric energy convertor is configured to determine pressures on both the sides of the piston and convert the determined pressure difference into electric current. The electric current is consumed by the transmitter and hence, the transmitter generates a signal. The signal is wirelessly transmitted to the receiver through the hydraulic cylinder. The receiver disposed on the hydraulic cylinder receives the signal through various components of the hydraulic cylinder. The signal is used to determine the position of the piston.

### TECHNICAL FIELD

The present invention is related to hydraulic cylinders, more particularly to a position sensor assembly for sensing the position of a piston in a hydraulic cylinder.

### BACKGROUND

Hydraulic cylinders-piston assemblies are used in different type of machines for a number of industrial applications such as construction, forestry, agriculture, mining and excavation. Different types of machines may include a wheel loader, an excavator, a track type tractor, a farm tractor, crane, paver, dozer, and the like. Traditionally, a human operator controls a hydraulic cylinder-piston assembly based on visual observation. Mere visual observation may not give accurate output and may damage the equipment. Such hydraulic cylinder-piston assemblies may be automatically controlled for predefined operating cycles. Further, for automatic control, the position/velocity of the piston needs to be determined for efficient and smooth functioning of the hydraulic cylinders-piston assemblies.

Various kinds of sensors, such as linear displacement transducers (LDT), magnetostrictive sensors, electromagnetic sensors, ultrasonic sensors, hall-effect sensors, radio frequency (RF) sensors, can be used as position sensing devices. However, the hydraulic cylinders may be exposed to harsh environmental conditions. For example, during a particular operation cycle, the cylinder may be subjected to vibrations. The sensors may be affected by vibrations and consequently may lack absolute position sensing capabilities.

### SUMMARY OF THE DISCLOSURE

It is an object of the disclosure to provide a position sensor assembly to determine the position of a piston in a hydraulic cylinder.

It is an object of the disclosure to provide a position sensor assembly that is protected from the harsh environmental conditions in the hydraulic cylinder.

In accordance with an embodiment of the present disclosure, a position sensor assembly for a hydraulic cylinder is provided. The hydraulic cylinder includes a cylinder body with a piston attached to a piston rod. The piston and the piston rod are disposed inside the cylinder body. The position sensor assembly includes a pressure to electric energy convertor. The pressure to electric energy convertor is disposed inside the piston. Working fluid in the hydraulic cylinder acts on the pressure to electric energy convertor through fluid ports, which are provided on both sides of the piston. The pressure to electric energy convertor is configured to determine pressure difference of the working fluid on both sides of the piston inside the cylinder. Further, the pressure to electric energy convertor converts the pressure difference into electric current. The position sensor assembly further includes a transmitter and a receiver. The transmitter is disposed in the piston and consumes electric current from the pressure to electric energy convertor. The transmitter further generates a signal based on the electric current and thereafter transmits the signal. The signal propagates through the hydraulic cylinder to the receiver. The receiver is disposed on the hydraulic cylinder and is configured to receive the signal transmitted by the transmitter. The position of the piston can be determined based on the signal received by the receiver.

### BRIEF DESCRIPTION OF THE DRAWINGS

FIG. 1 is an illustration of a hydraulic excavator embodying the disclosed position sensor assembly; and

FIG. 2 illustrates a hydraulic cylinder with a position sensor assembly in accordance with an exemplary embodiment.

### DETAILED DESCRIPTION

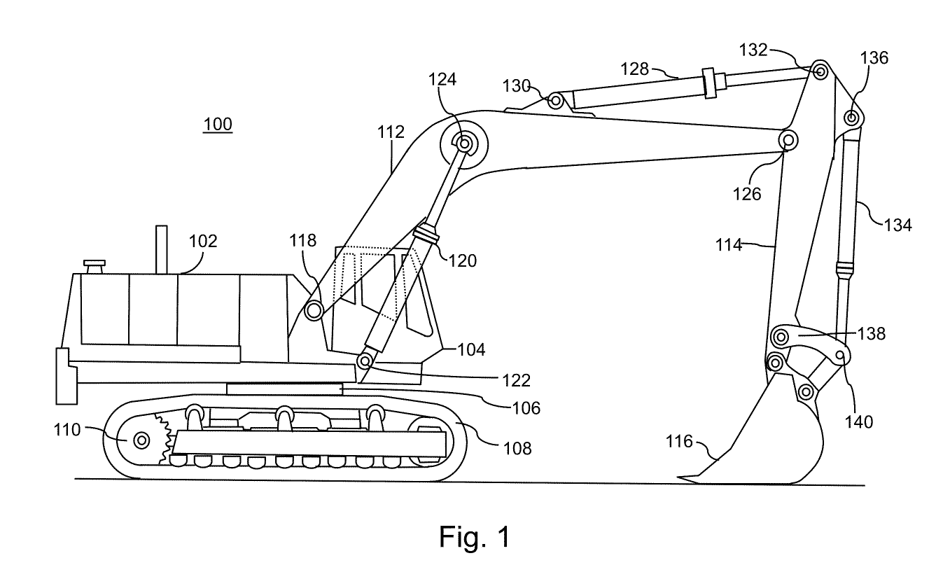

Shown in FIG. 1 is an illustration of a hydraulic excavator 100. The hydraulic excavator 100 includes an upper structure, a lower structure and a working element. The upper structure includes a rotatably mounted body 102 and an operator cab 104. The operator cab 104 can be connected to the body 102 and houses one or more control devices for controlling the operations of the hydraulic excavator 100.

The lower structure includes an undercarriage 106 supported by a pair of tracks 108 and sprocket 110. The body 102 mentioned as a part of upper structure is mounted on the undercarriage 106.

The working element comprises a boom 112, a dipper 114, a work tool 116 and a plurality of hydraulic cylinders. The boom 112 can be mounted on a pivot point 118 on a forward end of the body 102. The boom 112 can be moved vertically with the help of a hydraulic cylinder 120. A lower end of the hydraulic cylinder 120 can be pivoted to a forward end of the body 102 at a pivot point 122 and an upper end of the hydraulic cylinder 120 can be pivotally mounted on the boom 112 at a pivot point 124.

The dipper arm 114 can be pivotally connected to forward end of the boom 112 at a pivot point 126. The work tool 116 can be pivotally mounted on the lower end of the dipper arm 114. A hydraulic cylinder 128 can have a first end mounted by pivot point 130 on the boom 112 and a second end mounted on an upper end of the dipper arm 114 at a pivot point 132. Similarly, a hydraulic cylinder 134 has a first end pivotally connected to the upper end of the dipper arm 114 by pivot point 136 and a second end pivotally connected to a linkage 138 by pivot point 140.

In an embodiment, the work tool 116 can be a bucket, a blade, a ripper, a grapple, a breaker, and the like.

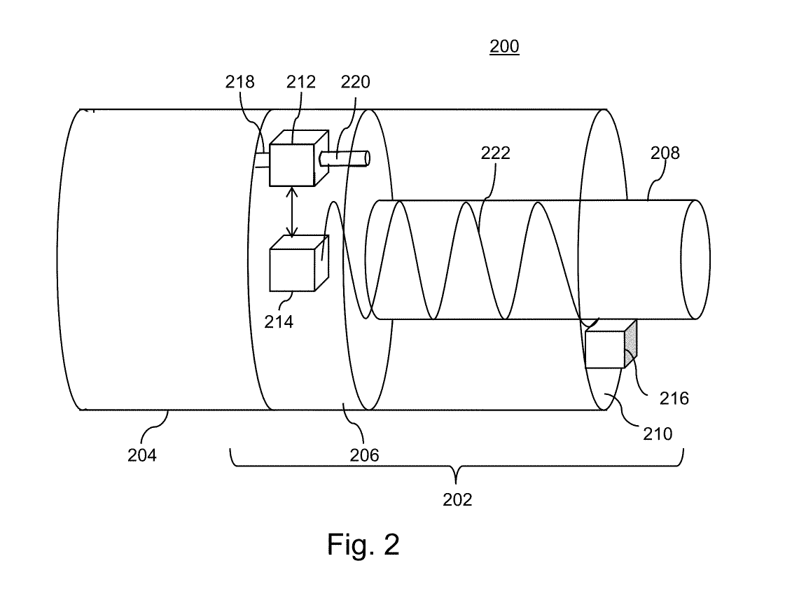

In an embodiment, the disclosed idea can be related to the above mentioned hydraulic cylinders 120, 128 and 134 in the hydraulic excavator 100. The hydraulic cylinders 120, 128, and 134 can include a position sensor assembly (not shown in Figure). The position sensor assembly can be configured to sense the position of a piston in the hydraulic cylinders 120, 128 and 134. The position sensor assembly is further described in FIG. 2. Although the present disclosure describes the idea as used in a hydraulic excavator 100, it will be appreciated that the disclosed idea can be implemented in other machines like loaders, scrapers, graders, agricultural machines, and the like, without departing from the scope of the present disclosure.

FIG. 2 illustrates a hydraulic cylinder 200 with a position sensor assembly 202 in accordance with one exemplary embodiment. The hydraulic cylinder 200 can include a cylinder body 204, a piston 206, and a rod 208. In an embodiment, the cylinder body 204 can be a hollow cylinder with the piston 206 disposed inside the hollow cylinder. The piston 206 can divide the hollow cylinder in two chambers on either side of the piston 206. One side of the piston 206 can be connected with the rod 208. In other words, the piston 206 can be connected with the rod 208 and disposed inside the cylinder body 204. Hence, the piston 206 divides the cylinder body 204 in two chambers. One chamber can be at the side of the rod 208. This chamber can be referred to as an upper chamber. Another chamber can be other side of the piston 206, opposite to the rod 208. This chamber can be referred to as lower chamber. Hence, the cylinder body 204 can be said to have a rod end at the upper chamber side and a head end at the lower chamber. The cylinder body 204 can be closed at both the ends by a cap or a cover plate, such as cap 210. The cylinder body 204 can also include corresponding ports (not shown) connected with the cylinder body 204 for the entry and exit of a working fluid in the upper chamber and the lower chamber. It can be contemplated, that the piston 206 can be configured to slide back and forth within the cylinder body 204 between the rod end and the head end. In other words, the piston 206 can move within the cylinder body 204 when the working fluid is supplied in the upper chamber or the lower chamber through the fluid ports. In an embodiment, the working fluid in the cylinder body 204 can be a hydraulic fluid, pressurized air or any other suitable medium known in the art.

In an embodiment, the position sensor assembly 202 can include a pressure to electric energy convertor 212, a transmitter 214, and a receiver 216. The pressure to electric energy convertor 212, hereinafter referred to as the convertor 212, can be disposed inside the piston 206. The convertor 212 can be disposed inside the body of the piston 206 thereby protecting the convertor 212 from environmental conditions. In an embodiment, the piston 206 can be provided with fluid port 218 and 220. The fluid port 218 and 220 can be a hole or cavity on either side of the piston 206. In other words, one hole or cavity can be created on opposite sides of the piston 206. It can be contemplated that the convertor 212 can be housed inside the piston 206 such that the convertor 212 is embedded inside the piston 206 between the fluid port 218 and 220. Hence, the pressure applied by the working fluid on the piston 206 in the lower chamber and the upper chamber can be sensed by the convertor 212 through the port 218 and 220 respectively.

In other words, the working fluid can cause a pressure to be applied on the piston 206 while expanding and/or retracting of the hydraulic cylinder 200. This pressure from the working fluid can be exposed to the convertor 212. In accordance with an embodiment the fluid port 218 and 220 may be connected such as to form a cavity or pass through hole inside the piston 206 in a way such that some working fluid may flow through the convertor 212.

In an embodiment, the convertor 212 can be a transducer configured to convert pressure difference into electric current. Hence, pressure applied by the working fluid on the piston 206 can be converted into electric current by the convertor 212. For example, during extension of the hydraulic cylinder 200, the working fluid may exit from the upper chamber on the rod end side of the piston 206 and simultaneously enter the lower chamber on the head end side of the piston 206. It can be contemplated that the pressure of the working fluid in the upper chamber on the rod end side of the piston 206 can be lower than the pressure of the working fluid in the lower chamber. Hence, there can be a difference in pressure in upper and lower chambers on the two side of the piston 206. The convertor 212 can be configured to determine the pressure difference and convert the pressure of the working fluid in both chambers, through the port 218 and 220, to electric current. Thus, the convertor 212 can determine a pressure difference across the piston 206 and generate an electric current based on the pressure difference between the two chambers. In other words, the convertor 212 can convert the mechanical energy/pressure of the working fluid into electrical current. In an embodiment, some of the electrical current could be temporarily stored inside the convertor 212 by using capacitors, rechargeable batteries, or mechanical springs.

The electric current from the convertor 212 can be transferred to the transmitter 214. The transmitter 214 can be disposed in the body of the piston 206. The transmitter 214 can be configured to consume the electric current generated by the convertor 212 from the pressure difference. In other words, the transmitter 214 can use to electric current to perform its functions. The transmitter 214 can be further configured to generate and transmit a signal 222 based on the electric current. The signal 222 may be a square wave, a sine wave, a triangular wave, or similar waves at one or more frequencies and amplitudes, such as ultrasound frequencies, radio frequencies or the like. The signal 222 can propagate from the transmitter 222 to the receiver 216 through various components of the hydraulic cylinder 200. For example, the signal 222 can travel through the piston 206 and then through the rod 208 in one direction, as shown in FIG. 2. In another example, the signal 222 can travel through the piston 206, through the rod 208, and then through the rod seals or wear band (not shown in figure), the cap 210, and then through the cylinder body 204. Another way could be through the piston 206, through the piston seals (not shown in figure), and then through the cylinder body 204 in both directions relative to the location of the piston 206. In another example, the signal 222 can travel through the working fluid. The signal 222 can carry information of the position of the piston 206 as determined by the convertor 212. In other words, the convertor 212 can determine the pressure difference and convert the pressure difference into electrical current. The transmitter 214 can consume the electrical current and also generate the signal 222 corresponding to the electrical current to indicate a position of the piston 206. The signal 222 indicating the position of the piston 206 can be communicated from the transmitter 214 to the receiver 216.

At the receiver 216, the signal 222 can be received. The receiver 216 can be mounted on the outside of the cylinder body 204 at various locations. As shown in FIG. 2, the receiver 216 could be mounted near the rod 208 such that it receives the signals 222 that were transmitted through the rod 208. In another embodiment, the receiver 216 could also be mounted in a similar location to receive the signals 222 that were transmitted through the cylinder body 204 or transmitted through both the cylinder body 204 and the rod 208. In another embodiment, the receiver 216 could also be mounted near the head end and the rod end of the cylinder body 204.

In an aspect of the disclosure, the receiver 216 can determine the information of the position of the piston 206 from the signal 222 and communicate the information to a control module (not shown). In one aspect of the idea, the signal 222 can be decoded to determine a position of the piston 206 at the control module by using an algorithm or a formula. In another aspect of the idea, the control module accesses a pre-stored table which contains predetermined values of the signals. The signal 222 received by the receiver 216 can be compared with the predetermined values of the signal in the pre-stored table. Each signal in the pre-stored table can correspond to a pressure difference. In turn each pressure difference can correspond to a specific position of the piston 206. And, hence the position of the piston 206 inside the cylinder body 204 can be determined. In an embodiment, the receiver 216 can have either a wired or wireless connection to the control module depending on the application and environmental factors.

### INDUSTRIAL APPLICABILITY

The disclosed position sensor assembly 202 for hydraulic cylinders 200 can be used in construction and mining equipment, such as excavators, wheel loaders, backhoe loaders, bulldozers, forklift trucks, graders, scrapers and the like. In the given embodiments of the disclosure, the position sensor assembly 202 for the piston 206 is used to determine the position of the piston 206. The position sensor assembly 202 can be utilized to implement an automatic control system for lifting or tilting certain work elements like the boom 112, the dipper 114 and the work tool 116. The automatic control system increases efficiency and accuracy of an operation while positioning the work tool 116. It further eliminates operator fatigue and manipulation of work tool 116.

In a typical digging operation, the operator has to monitor the depth of the work tool 116 to control the digging operation. To dig to a specific depth, the operator needs the current position data of the work tool 116. Based on the current position data, current displacement of the piston 206 or the rod 208 can be calculated. If the operator has to dig deeper, the rod 208 needs to be extended. Prior to extension, the position of the piston 206 can be determined and then the required extension command can be issued. During the expansion of a hydraulic cylinder-piston assembly, the working fluid flows through a port in the lower chamber at the head end of the of the cylinder body 204. The entry of fluid in the lower chamber of the cylinder body 204 can push the piston 206 towards the upper chamber of the cylinder body 204. The working fluid in the upper chamber exits the cylinder body 204 when the piston 206 moves towards the rod end. This results in a high pressure in the lower chamber of the cylinder body 204 and a low pressure in the upper chamber of the cylinder body 204. In accordance with the disclosed idea, the convertor 212 disposed inside the piston 206 detects the pressure difference between the working fluid in the upper chamber and the lower chamber of the cylinder body 204. Further, the convertor 212 converts the pressure difference into electric current. The electric current can be then supplied to the transmitter 214. The transmitter 214 consumes the electric current and generates the signal 222 based on the electric current. This signal 222 can be transmitted by the transmitter 214 to the receiver 216. The signal 222 can be further conveyed to the control module by the receiver 216. Use of wireless transmission channel, through the cylinder body 204, the piston 206, and the rod 208 to transmit the signal 222 from the transmitter 214 to the receiver 216 can be a benefit of the disclosed idea. The transmission can be ultrasonic or the like providing the advantage of streamlined data transmission and is not affected by the vibrations and extreme environmental conditions of a typical worksite. The control module determines the position of the piston 206 based on the signal 222 and supervises the movement of the work tool 116 during machine operations. According to one aspect of the disclosure, the convertor 212 can also be configured to determine ambient temperature in the cylinder body 204 and velocity of the piston 206 in the cylinder 204. Such ambient temperature and velocity inputs can be converted into signal 222 and directed to the control module as described above.

Other features, advantages and objects can be obtained from the drawings, description and imminent claims of the disclosure.

What is claimed is:

1. A position sensor assembly for a hydraulic cylinder having a cylinder body with a piston attached to a rod disposed inside the cylinder body, the sensor assembly comprising:
a pressure to electric energy convertor disposed inside the piston, configured to determine a pressure difference of working fluid on both sides of the piston inside the cylinder, and convert the pressure difference into electric current;
a transmitter disposed in the piston, configured to:
consume electric current from the pressure to electric energy convertor;
generate a signal based on the electric current; and
transmit the signal through the hydraulic cylinder; and
a receiver disposed on the hydraulic cylinder configured to receive the signal from the transmitter, wherein the signal is used to determine a position of the piston.
